(19) United States
(12) Patent Application Publication
(10) Pub. No.: US 2022/0158583 A1
(43) Pub. Date: May 19, 2022

(54) Cargo Boxes as Mobile Solar Charging Platforms

(71) Applicant: Paragon Design Studio, Inc., Beverly Hills, CA (US)

(72) Inventor: Eric Hammerlund, Los Angeles, CA (US)

(21) Appl. No.: 16/951,902

(22) Filed: Nov. 18, 2020

(51) Int. Cl. H02S 10/40; H02S 20/30; H02S 40/32

(52) U.S. Cl. CPC H02S 10/40; H02S 40/32; H02S 20/30

(57) ABSTRACT

In some embodiments, a cargo box includes a rigid bottom, a rigid top slidably connected to the rigid bottom, and a solar panel coupled to an interior side of the rigid bottom. The rigid top is configured to slide between an open position and a closed position. In the closed position, the rigid top covers the solar panel and the interior side of the rigid bottom. The solar panel is exposed with the rigid top in the open position.

### TECHNICAL FIELD

This disclosure relates to solar panels, and more specifically to cargo boxes that serve as cases for solar panels.

### BACKGROUND

Electric vehicles have limited range due to their limited battery capacity. Charging an electric vehicle takes longer than refueling an internal-combustion-engine, and charging stations are not as common as gas stations. These difficulties cause “range anxiety,” which makes people less likely to buy electric vehicles and makes electric-vehicle owners less likely to use their electric vehicles for long trips.

### SUMMARY

In some embodiments, a cargo box includes a rigid bottom, a rigid top slidably connected to the rigid bottom, and a solar panel coupled to an interior side of the rigid bottom. The rigid top is configured to slide between an open position and a closed position. In the closed position, the rigid top covers the solar panel and the interior side of the rigid bottom. The solar panel is exposed with the rigid top in the open position.

In some embodiments, a cargo box includes a rigid bottom, a rigid top detachably connected to the rigid bottom, a solar panel coupled to an interior side of the rigid top, and an arm coupled between the rigid bottom and the rigid top.

### BRIEF DESCRIPTION OF THE DRAWINGS

For a better understanding of the various described embodiments, reference should be made to the Detailed Description below, in conjunction with the following drawings.

FIG. 1A is a side view of a vehicle with a closed cargo box, mounted on the vehicle's roof, that contains a solar panel, in accordance with some embodiments.

FIG. 1B is a side view of a vehicle with an open cargo box, mounted on the vehicle's roof, that contains a solar panel, in accordance with some embodiments.

FIG. 1C is a plan view of a vehicle with a closed cargo box, mounted on the vehicle's roof, that contains a solar panel, in accordance with some embodiments.

FIG. 1D is a plan view of a vehicle with an open cargo box, mounted on the vehicle's roof, that contains a solar panel, in accordance with some embodiments.

FIGS. 2A and 2B are side views of a vehicle with an open cargo box mounted on the vehicle's roof, an arm extending from the open cargo box, and a solar panel mounted on the arm, in accordance with some embodiments.

FIG. 2C is a front view of a vehicle with an open cargo box mounted on the vehicle's roof, an arm extending from the open cargo box, and a solar panel mounted on the arm, in accordance with some embodiments.

FIGS. 3A and 3B are front views of a vehicle with an open cargo box mounted on the vehicle's roof, an arm extending from the open cargo box, and a folding solar panel mounted on the arm, in accordance with some embodiments.

FIGS. 4A and 4B are side views of a vehicle with an open cargo box mounted on the vehicle's roof, a scissor lift extending from the open cargo box, and a solar panel mounted on the scissor lift, in accordance with some embodiments.

FIG. 5A is a side view of a vehicle with a closed cargo box, mounted on the vehicle's roof, that contains a solar panel, in accordance with some embodiments.

FIG. 5B is a front view of a vehicle with a closed cargo box, mounted on the vehicle's roof, that contains a solar panel, in accordance with some embodiments.

FIG. 5C is a front view of a vehicle with an open cargo box, mounted on the vehicle's roof, that contains a solar panel, in accordance with some embodiments.

FIGS. 5D-5F are side views of a vehicle with an open cargo box, mounted on the vehicle's roof, that contains a solar panel, with the solar panel rotated to different positions, in accordance with some embodiments.

FIG. 6 is a cross-sectional view of a mechanical attachment for mounting a cargo box on a roof rack, in accordance with some embodiments.

FIG. 7 shows a cargo box mounted on a post in accordance with some embodiments.

FIG. 8 shows a cargo box mounted on a building in accordance with some embodiments.

Like reference numerals refer to corresponding parts throughout the drawings and specification.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

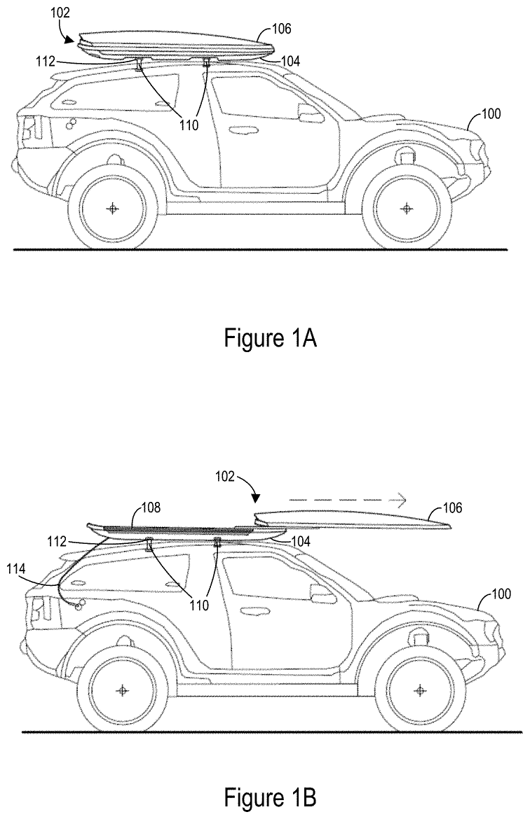

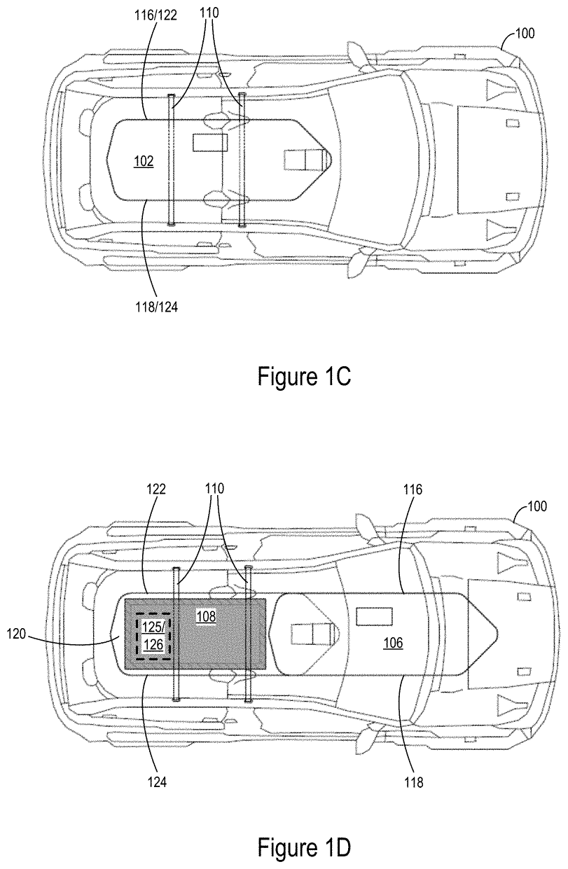

FIGS. 1A-1D show a vehicle 100 with a cargo box 102 mounted on the vehicle's roof, in accordance with some embodiments. The cargo box 102 contains a solar panel 108. FIGS. 1A and 1B are side views of the vehicle 100 and cargo box 102, while FIGS. 1C and 1D are plan views of the vehicle 100 and cargo box 102. The vehicle 100 may be an electric vehicle (e.g., a battery-powered electric vehicle (BEV) or a plug-in hybrid electric vehicle (PHEV)). Examples of the vehicle 100 include, without limitation, a car, van, sport-utility vehicle, bus, truck, or recreational vehicle. The cargo box 102 has a rigid bottom 104 and a rigid top 106. For example, the rigid bottom 104 and rigid top 106 may be plastic, metal, and/or a composite material. The rigid top 106 is slidably connected to the rigid bottom 104, such that it can slide back and forth between a closed position and an open position with respect to the rigid bottom 104. FIGS. 1A and 1C show the rigid top 106 in the closed position, while FIGS. 1B and 1D show the rigid top 106 in the open position, in accordance with some embodiments. In the closed position, the rigid top 106 covers the solar panel 108 and the interior side 120 (FIG. 1D) of the rigid bottom 104 (i.e., the side of the rigid bottom 104 on the interior of the cargo box 102). The solar panel is enclosed within the cargo box 102 with the rigid top 106 in the closed position. In the open position, the solar panel 108 is exposed. The solar panel is coupled, directly or indirectly, to the rigid bottom 104 (e.g., to the interior side 120 of the rigid bottom 104).

In some embodiments, the cargo box 102 is mounted to a roof rack 110 on the vehicle 100. For example, the cargo box 102 has mountings 112 (e.g., clamps, brackets, or straps) coupled to (e.g., on) the rigid bottom 104 (e.g., the exterior side of the rigid bottom 104) that can be connected to the roof rack 110 to mount the cargo box 102 on the roof rack 110.

In some embodiments, the rigid top 106 slides forward and backward with respect to the rigid bottom 104 and the vehicle 100. For example, the rigid top 106 extends over the windshield and at least a portion of the hood of the vehicle 100 in the open position, and slides in a direction substantially parallel to the sides of the vehicle 100, assuming even mounting of the cargo box 102 on the vehicle 100. A first longitudinal side 122 of the rigid bottom 104 is slidably connected to a first longitudinal side 116 of the rigid top 106. A second longitudinal side 124 of the rigid bottom 104 is slidably connected to a second longitudinal side 118 of the rigid top 106. For example, the first and second longitudinal sides 116 and 118 of the rigid top have extensions mounted in respective tracks or grooves of the first and second longitudinal sides 122 and 124, or vice-versa.

The solar panel 108, when exposed to sunlight and suitably biased, produces a DC current (i.e., generates DC power). In some embodiments, the cargo box 102 includes a DC-DC converter 125 and/or a DC-AC inverter 126 (e.g., positioned beneath the solar panel 108, as shown in FIG. 1D, or elsewhere within the cargo box 102) to adapt the power from the solar panel. The DC-DC converter 125 changes the voltage of the DC power generated by the solar panel 108. The DC-AC inverter 126 converts the direct current produced by the solar panel 108 to alternating current. In some embodiments, the cargo box 102 also includes an extendible power cord 114 (FIG. 1B) that is electrically coupled to the DC-DC converter 125 and/or the DC-AC inverter 126 to provide the adapted power. The power cord 114 may be pulled out of the cargo box 102 (e.g., through the rigid bottom 104) and may be retractable, such that it retracts into the cargo box 102 (e.g., through the rigid bottom 104) when released. The power cord 114 may end with an adaptor that can be plugged into the vehicle 100 to charge the battery of the vehicle 100, as shown in FIG. 1B. Alternatively, the power cord 114 may be hard-wired to extend through a surface of the vehicle 100 to connect to a power cable in the chassis of the vehicle 100 that connects to the battery of the vehicle 100. Other examples of connections for the power cord 114 include, without limitation, connections to a battery bank to charge the battery bank, to a structure (e.g., building) to provide power for the structure, and to a multi-port charger to allow charging of multiple devices (e.g., portable devices such as phones and computers; vehicles such as e-scooters and e-bikes).

In some embodiments, the solar panel 108 is attached (e.g., fixedly attached) to the interior side 120 of the rigid bottom 104, with the face of the solar panel 108 (or one face of the solar panel 108, if the solar panel 108 is bifacial) facing away from the interior side 120 of the rigid bottom 104. For example, the solar panel 108 is attached to the interior side 120 of the rigid bottom 104 such that it faces straight up toward the sky with the rigid top 106 in the open position. In some embodiments, multiple solar panels 108 (e.g., an array of solar panels) are attached (e.g., fixedly attached) to the interior side 120 of the rigid bottom 104 (e.g., with their faces facing away from the interior side 120 of the rigid bottom 104).

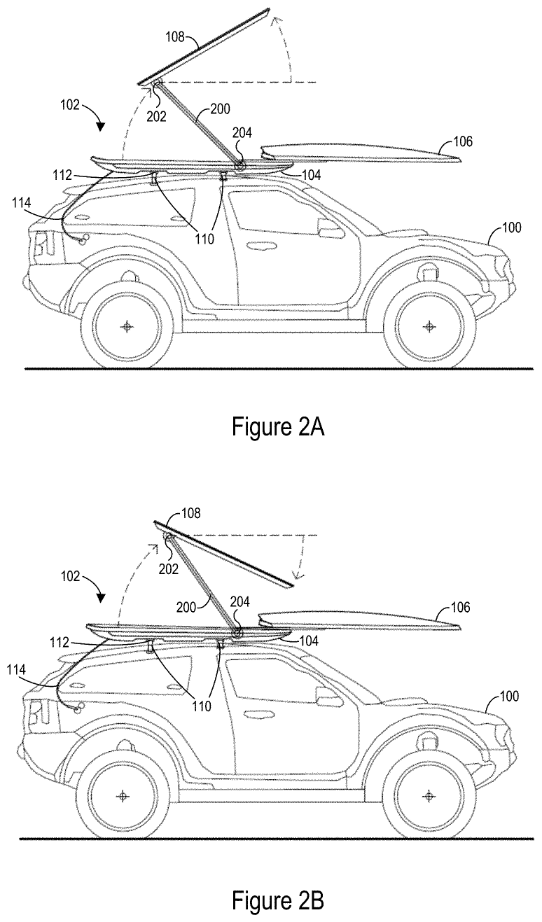

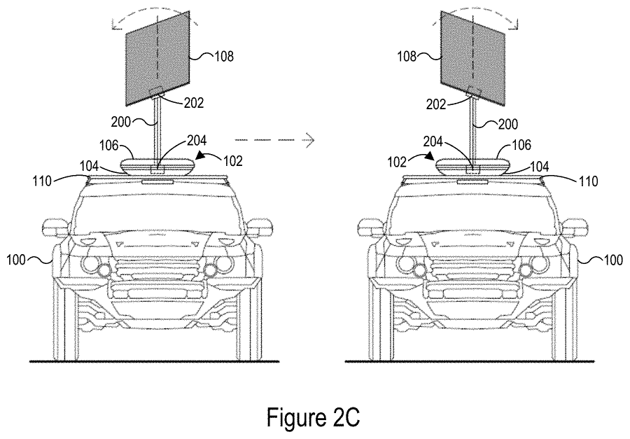

Alternatively, the solar panel 108 is coupled to the rigid bottom 104 (e.g., to the interior side 120, FIG. 1D, of the rigid bottom 140) by an arm 200, as shown in FIGS. 2A-2C in accordance with some embodiments. The arm 200 has a first pivotable connection 202 connected to the solar panel 108 and a second pivotable connection 204 connected to the rigid bottom 104 (e.g., to the interior side 120, FIG. 1D, of the rigid bottom 104). To deploy the solar panel 108, the rigid top 106 is slid into the open position and the arm 200 is raised to raise the solar panel 108 out of the open cargo box 102 and position it (e.g., so that it faces the sun). To stow the solar panel 108, the solar panel 108 is lowered into the open cargo box 102 by lowering the arm 200 and pivoting and/or rotating the solar panel 108 as needed, and the rigid top 106 is then slid into the closed position. The arm 200 is enclosed within the cargo box 102 when the cargo box 102 is closed (i.e., with the rigid top 106 in the closed position). In some embodiments, the arm has a rigid segment that extends from the first pivotable connection 202 to the second pivotable connection 204. Alternatively, the arm 200 is articulated, with one or more joints at intermediate positions along the arm 200 between the first pivotable connection 202 and the second pivotable connection 204.

FIGS. 2A and 2B are side views of the vehicle 100 and cargo box 102, with the cargo box 102 open (i.e., with the rigid top 106 in the open position) and the arm 200 extending upward out of the open cargo box 102. As FIGS. 2A and 2B show, the pivotable connections 202 and 204 provide a first degree of freedom for positioning the solar panel 108: the solar panel may be slanted forward (FIG. 2B) or backward (FIG. 2A), or positioned to be flat horizontally such that it faces straight up. FIG. 2C is a front view of the vehicle 100 and open cargo box 102 illustrating a second degree of freedom that may be provided by at least one of the pivotable connections 202 or 204: the solar panel 108 may be rotated from side to side (i.e., rotated radially about a radial axis extending through the arm 200). To provide this side-to-side rotation, at least one of the pivotable connections 202 or 204 is radially rotatable with respect to the arm 200. The solar panel 108 thus may be rotatable with two degrees of freedom.

In some embodiments, the solar panel 108 is positioned manually: a user lifts the solar panel 108 out of the open cargo box 102 and positions the solar panel 108 at a desired angle (e.g., facing the sun). Alternatively, the pivotable connections 202 and 204 are motorized, and the solar panel 108 may be positioned automatically. For example, the cargo box 102 or solar panel 108 may have a solar tracking system that automatically positions and re-positions the solar panel 108 (e.g., to track the sun and maximize power generation).

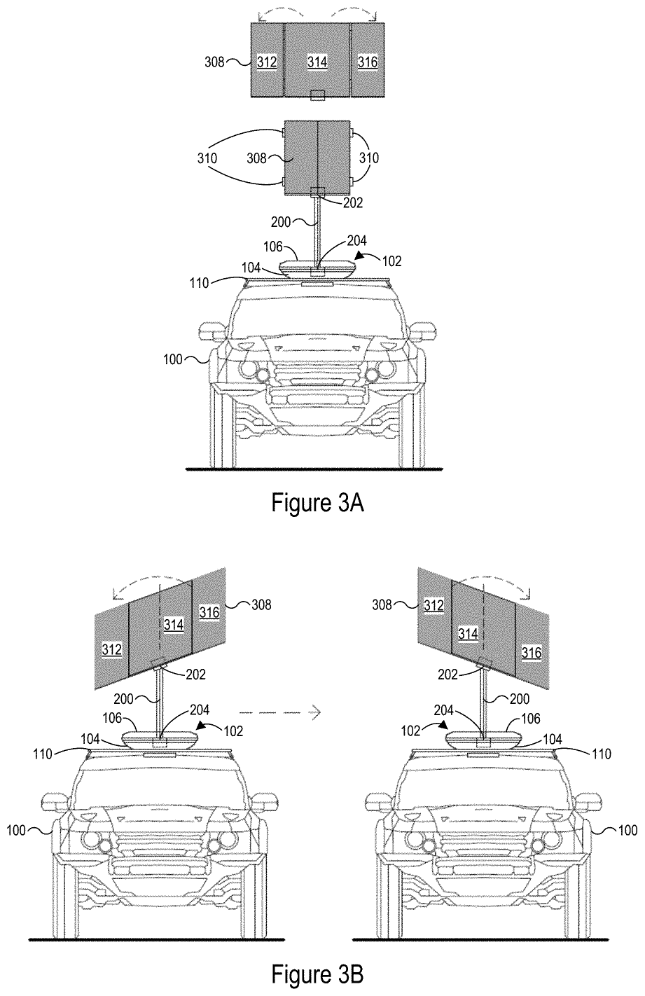

The solar panel 108 may be replaced with a folding solar panel that is folded up when the cargo box 102 is closed (i.e., with the rigid top 106 in the closed position) and that may be unfolded when the cargo box 102 is open (i.e., with the rigid top 106 in the open position). FIGS. 3A and 3B, which are front views of the vehicle 100 and cargo box 102 with the cargo box 102 open, show a folding solar panel 308 that is an example of such a folding solar panel. The folding solar panel 308 is coupled to the rigid bottom 104 (e.g., to the interior side 120, FIG. 1D, of the rigid bottom 104) by the arm 200. The first pivotable connection 202 connects the arm 200 to the solar panel 308. The second pivotable connection 204 connects the arm 200 to the rigid bottom 104 (e.g., to the interior side 120, FIG. 1D, of the rigid bottom 104). The solar panel 308 may be unfolded once the rigid top 106 has been slid to the open position to open the cargo box 102 and the solar panel 308 has been raised out of the cargo box 102 by raising the arm 200 (i.e., by placing the arm 200 in a raised position).

In some embodiments, the solar panel 308 has hinges 310 that allow it to fold and unfold. The solar panel 308 may be divided into a first portion 312, a second portion 314, and a third portion 316. The first portion 312 folds over one side of the second portion 314 and the third portion 316 folds over the other side of the second portion 314. With the solar panel 308 unfolded, the faces of the first portion 312, second portion 314, and third portion 316 may all be positioned to allow for solar-power generation (e.g., may be positioned to face the sun). Positioning the solar panel 308 may include raising the arm 200, slanting the solar panel 308, and/or radially rotating the solar panel 308. This positioning is performed, for example, in the manner described for FIGS. 2A-2C.

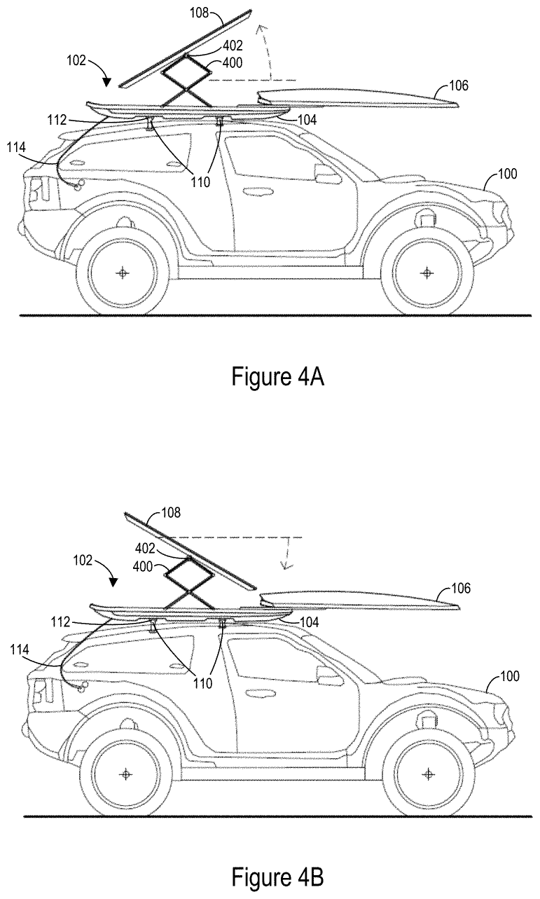

In some embodiments, the solar panel 108 (or alternatively the folding solar panel 308, FIGS. 3A-3B) is coupled to the rigid bottom 104 (e.g., to the interior side 120, FIG. 1D, of the rigid bottom 140) by a scissor lift 400, as shown in FIGS. 4A and 4B in accordance with some embodiments. The scissor lift 400 has a pivotable connection 402 connected to the solar panel 108. The pivotable connection 402 allows the solar panel 108 to be tilted forward and backward, as shown in FIGS. 4A-4B (as well as positioned horizontally flat), and/or side to side. In some embodiments, the pivotable connection 402 is also rotatable, such that the solar panel 108 may be rotated. To deploy the solar panel 108 (or the folding solar panel 308), the rigid top 106 is slid into the open position and the scissor lift 400 is extended to raise the solar panel 108 out of the open cargo box 102, and the pivotable connection 402 is used to pivot and/or rotate the solar panel 108 (e.g., so that it faces the sun). To stow the solar panel 108, the solar panel 108 is lowered into the open cargo box 102 by collapsing the scissor lift 400 and pivoting and/or rotating the solar panel 108 as needed, and the rigid top 106 is then slid into the closed position. The collapsed scissor lift 400 is enclosed within the cargo box 102 when the cargo box 102 is closed (i.e., with the rigid top 106 in the closed position). In some embodiments, the scissor lift 400 is motorized and can be raised and lowered automatically, and/or the pivotable connection 402 is motorized to pivot and/or to rotate the solar panel 108 automatically. For example, the motorized scissor lift 400 and/or motorized pivotable connection 402 may be controlled by a solar tracking system in the cargo box 102 or on the solar panel 108. Alternatively, the scissor lift 400 is extended and collapsed manually to raise and lower the solar panel 108, and/or the solar panel 108 is pivoted and/or rotated manually.

FIGS. 1A-4B illustrate various embodiments in which a cargo box 102 has a rigid top 106 slidably connected to a rigid bottom 104. Other ways to implement a cargo box for storing a solar panel are possible. For example, the rigid top may be detachably connected to the rigid bottom.

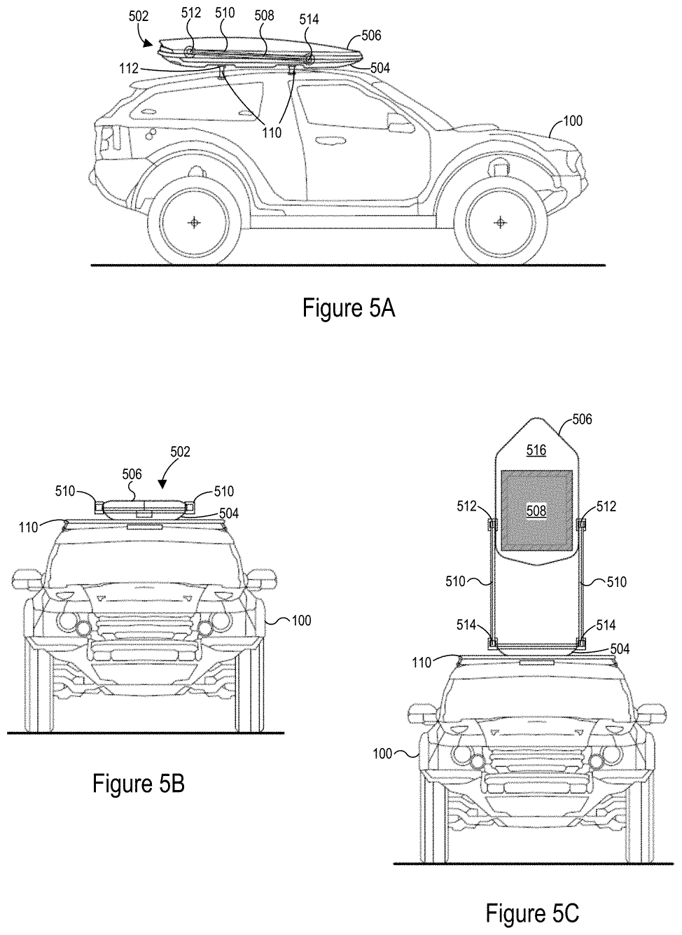

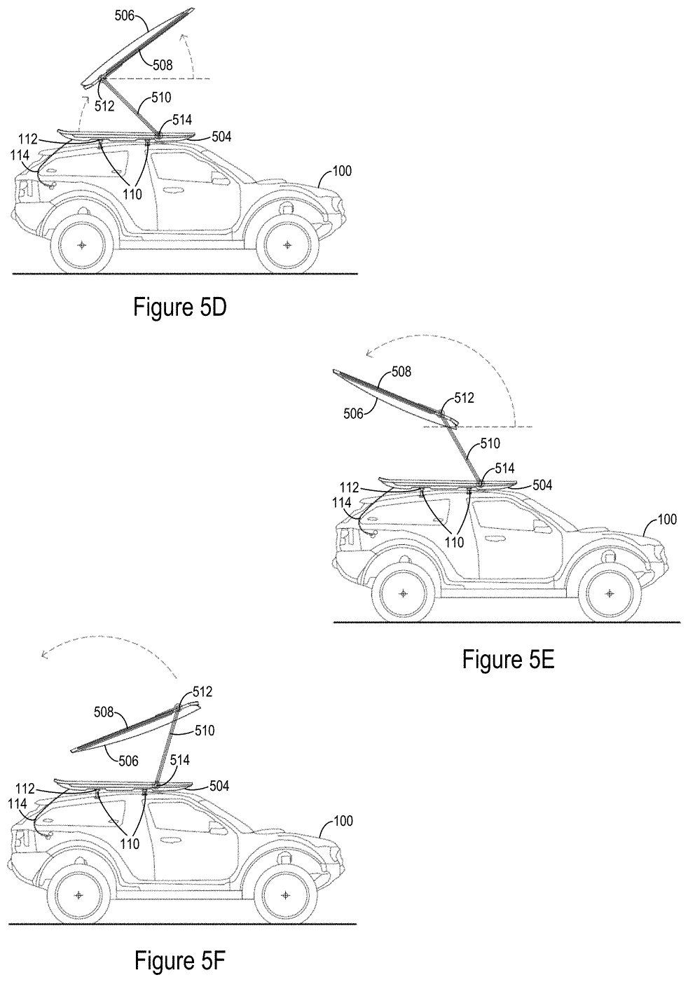

FIGS. 5A-5F show a vehicle 100 with a cargo box 502 mounted on the vehicle's roof, in accordance with some embodiments. The cargo box 502 contains a solar panel 508. The cargo box 502 has a rigid bottom 504 and a rigid top 506, which are detachably connected to each other. In some embodiments, the rigid bottom 504 and rigid top 506 are plastic, metal, and/or a composite material. FIGS. 5A and 5D-5F are side views of the vehicle 100 and cargo box 502, while FIGS. 5B and 5C are front views of the vehicle 100 and cargo box 502. In FIGS. 5A and 5B, the rigid bottom 504 and rigid top 506 are connected to each other (e.g., using latches), such that the cargo box 502 is closed and the rigid top 506 is held in position over the rigid bottom 504. In FIGS. 5C-5F, the rigid top 506 is detached from the rigid bottom 504, such that the cargo box 502 is open.

The solar panel 508 is attached (e.g., fixedly attached) to the interior side 516 (FIG. 5C) of the rigid top 506. The interior side 516 is the side of the rigid top 506 on the interior of the cargo box 502 when the cargo box 502 is closed. The face of the solar panel 508 (or one face of the solar panel 508, if the solar panel 508 is bifacial) faces away from the interior side 516 of the rigid top 506 (i.e., faces outward with respect to the rigid top 506). The solar panel 508 is exposed when the cargo box 502 is open but not when the cargo box 502 is closed. When the cargo box 502 is closed, the solar panel 508 is enclosed within the cargo box 502.

Arms 510 couple the rigid top 506 to the rigid bottom 504, both when the cargo box 502 is closed and when the cargo box 502 is open. The arms 510 thus are coupled between the rigid bottom 504 and rigid top 506. In some embodiments, two rigid arms 510 couple the rigid bottom 504 to the rigid top 506, one on each side (e.g., each longitudinal side) of the cargo box 502. In some embodiments, one of the rigid arms 510 is omitted, such that only one rigid arm 510 (e.g., situated on a longitudinal side of the cargo box 502) couples the rigid bottom 504 to the rigid top 506. In some embodiments, the rigid arm(s) 510 are situated outside (e.g., along each longitudinal side) of the cargo box 502.

In some embodiments, each arm 510 includes a first pivotable connection 512 that connects the arm 510 to the rigid top 506 and a second pivotable connection 514 that connects the arm 510 to the rigid bottom 504. Each arm 510 may also include a rigid segment 510 that extends from the first pivotable connection 512 to the second pivotable connection 514. The rigid segment(s) 510 may be situated outside (e.g., along each longitudinal side) of the cargo box 502. The pivotable connections 512 and 514 allow the rigid top 506, and thus the solar panel 508, to rotate when the rigid top 506 is detached from the rigid top 504 and the arms 510 have been raised above the rigid bottom 504 to provide clearance for the rotation. FIGS. 5D-5F illustrate this rotation, which occurs in the longitudinal plane (i.e., the side-view plane) of the cargo box 502 and vehicle 100 in accordance with some embodiments. This rotation allows the solar panel 508 to be positioned toward the sun to increase (e.g., optimize) solar-power generation.

In some embodiments, the solar panel 508 and rigid top 506 are positioned manually: a user lifts the rigid top 506 off of the rigid bottom 504, thus opening the cargo box 502, and positions the solar panel 508 at a desired angle (e.g., facing the sun). Alternatively, the pivotable connections 512 and/or 514 are motorized, and the solar panel 508 may be positioned automatically. For example, the cargo box 502 or solar panel 508 may have a solar tracking system that automatically positions and re-positions the rigid top 506 and solar panel 508 (e.g., to track the sun and maximize power generation).

In some embodiments, multiple solar panels 508 (e.g., an array of solar panels) are rigidly attached to the interior side 516 of the rigid top 506 (e.g., with their faces facing outward, away from the interior side 516 of the rigid top 506). In some embodiments, the solar panel 508 may be replaced with a folding solar panel that is folded up when the cargo box 502 is closed (i.e., with the rigid top 506 connected to the rigid bottom 504) and that can be unfolded when the cargo box 502 is open (i.e., with the rigid top 506 detached from the rigid bottom 504). For example, the folding solar panel may fold and unfold in the manner of the folding solar panel 308 (FIGS. 3A-3B).

In some embodiments, the cargo box 502 is mounted to a roof rack 110 on the vehicle 100. For example, the cargo box 502 has mountings 112 (e.g., clamps, brackets, or straps) coupled to (e.g., on) the exterior side of the rigid bottom 504 that can be connected to the roof rack 110 to mount the cargo box 502 on the roof rack 110.

In some embodiments, the cargo box 502 includes a DC-DC converter and/or a DC-AC inverter (e.g., DC-DC converter 125 and/or DC-AC inverter 126, FIG. 1D) to adapt the power from the solar panel. For example, a DC-DC converter and/or a DC-AC inverter is coupled to the interior side of the rigid top 506 or the rigid bottom 504. In some embodiments, the cargo box 502 also includes an extendible power cord 114 (FIGS. 5D-5F) that is electrically coupled to the DC-DC converter and/or a DC-AC inverter to provide the adapted power. The power cord 114 may be pulled out of the cargo box 502 (e.g., through the rigid bottom 504) and may be retractable, such that it retracts into the cargo box 502 (e.g., through the rigid bottom 504) when released. A power cable may run through an arm 510 to provide power generated by the solar panel 508 from the rigid top 506 to the rigid bottom 504 (e.g., from the solar panel 508 to a DC-DC converter or DC-AC inverter on the rigid bottom 504 that provides power to the power cord 114).

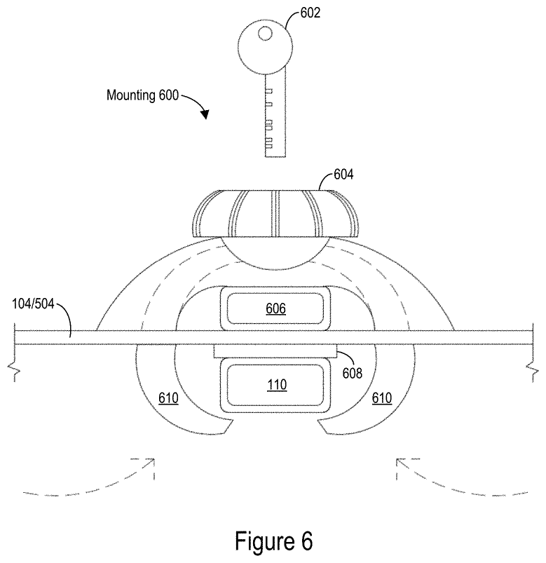

FIG. 6 is a cross-sectional view of a mechanical attachment 600 for mounting a cargo box (e.g., cargo box 102, FIGS. 1A-4B; cargo box 502, FIGS. 5A-5F) on the roof rack 110, in accordance with some embodiments. The mechanical attachment 600 may be an example of a mounting 112. The mechanical attachment 600 includes a mechanical twist dial 604, situated within the cargo box, for tightening and loosening clamps (e.g., mechanical scissor clamps) 610. When tightened, the clamps 610 clamp the cargo box to the roof rack 110, thereby connecting the mechanical attachment 600 to the roof rack 110. The twist dial 604 is situated inside the cargo box. The clamps 610 extend through the rigid bottom (e.g., rigid bottom 104 or 504) of the cargo box. This arrangement prevents the cargo box from being removed from the roof rack 110 without first opening the cargo box to access the twist dial 604, thus providing security (the cargo box may include a lock). The mechanical attachment 600 also includes a rubber gasket 608 attached to the exterior surface of the rigid bottom. To mount the cargo box on the roof rack 110, the roof rack 110 is positioned against the rubber gasket 608. Opposite the rubber gasket 608, on the interior surface of the rigid bottom, is a steel tube 606, which is attached to the interior surface of the rigid bottom to provide stability. The twist dial 604 may accept a key 602 for locking and unlocking the clamps 610.

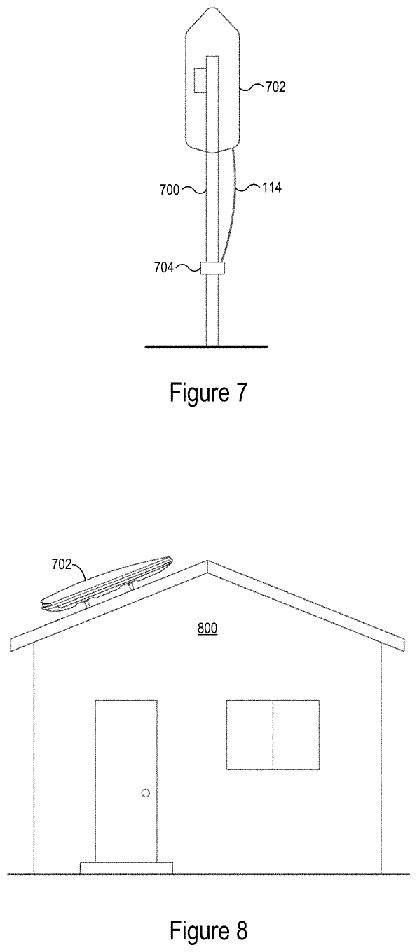

FIGS. 1A-5F illustrate various embodiments in which a cargo box 102 (FIGS. 1A-4B) or a cargo box 502 (FIGS. 5A-5F) is mounted on a vehicle 100. The cargo boxes 102 or 502 may be mounted on other items as well. FIG. 7 shows a cargo box 702 mounted on a post 700 in accordance with some embodiments. The cargo box 702, which contains a solar panel, may be an example of the cargo box 102 (FIGS. 1A-4B) or the cargo box 502 (FIGS. 5A-5F). The power cord 114 electrically couples the cargo box 702 to a charger 704 (e.g., a charging port or a multi-port charger). FIG. 8 shows the cargo box 702 mounted on a building 800 in accordance with some embodiments. The solar panel in the cargo box 702 may be used to provide power to the building 800. For example, the power cord 114 may be plugged into a port that connects to the AC mains for the building 800. The cargo box 702 may similarly be mounted on a different structure.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A cargo box, comprising:
a rigid bottom of the cargo box;
a rigid top of the cargo box, slidably connected to the rigid bottom, to slide between an open position and a closed position; and
a solar panel coupled to an interior side of the rigid bottom, wherein:
the rigid top covers the solar panel and the interior side of the rigid bottom in the closed position; and
the solar panel is exposed with the rigid top in the open position.

2. The cargo box of claim 1, wherein:
a first longitudinal side of the rigid bottom is slidably connected to a first longitudinal side of the rigid top; and
a second longitudinal side of the rigid bottom is slidably connected to a second longitudinal side of the rigid top.

3. The cargo box of claim 2, further comprising mountings, coupled to an exterior side of the rigid bottom, to connect to a roof rack on a vehicle.

4. The cargo box of claim 1, wherein the solar panel is attached to the interior side of the rigid bottom, with the face of the solar panel facing away from the interior side of the rigid bottom.

5. The cargo box of claim 1, further comprising an arm coupling the solar panel to the interior side of the rigid bottom.

6. The cargo box of claim 5, wherein the arm comprises:
a first pivotable connection connected to the solar panel;
a second pivotable connection connected to the interior side of the rigid bottom; and
a rigid segment extending between the first pivotable connection and the second pivotable connection.

7. The cargo box of claim 6, wherein at least one of the first pivotable connection or the second pivotable connection is radially rotatable with respect to the arm.

8. The cargo box of claim 6, wherein the first pivotable connection and the second pivotable connection are motorized.

9. The cargo box of claim 5, wherein the solar panel is a folding solar panel that is folded up with the rigid top in the closed position and is capable of being unfolded with the rigid top in the open position and the arm in a raised position.

10. The cargo box of claim 1, further comprising a scissor lift coupling the solar panel to the interior side of the rigid bottom.

11. The cargo box of claim 10, wherein the scissor lift comprises a pivotable connection connected to the solar panel.

12. The cargo box of claim 10, wherein:
the scissor lift is motorized to be raised and lowered automatically; and
the pivotable connection is motorized to pivot the solar panel automatically.

13. The cargo box of claim 10, wherein the solar panel is a folding solar panel that is folded up with the rigid top in the closed position and is capable of being unfolded with the rigid top in the open position and the scissor lift in a raised position.

14. The cargo box of claim 1, further comprising:
at least one of a DC-DC converter or DC-AC inverter to adapt power from the solar panel; and
an extendible power cord, electrically coupled to the DC-DC converter or DC-AC inverter, to provide the adapted power.

15-20. (canceled)

21. The cargo box of claim 2, wherein:
the first and second longitudinal sides of the rigid bottom comprise respective tracks or grooves; and
the first and second longitudinal sides of the rigid top comprise respective extensions mounted in the respective tracks or grooves.

22. The cargo box of claim 2, wherein:
the first and second longitudinal sides of the rigid top comprise respective tracks or grooves; and
the first and second longitudinal sides of the rigid bottom comprise respective extensions mounted in the respective tracks or grooves.
